(19) United States
(12) Patent Application Publication
(10) Pub. No.: US 2008/0065564 A1
(43) Pub. Date: Mar. 13, 2008

(54) Repossession method and system

(75) Inventors: J. Joseph Gualandri, Metamora, IL (US); Milton R. Long, Franklin, TN (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/514,587

(22) Filed: Aug. 31, 2006

(51) Int. Cl. G06F 17/00; G08G 1/123

(52) U.S. Cl. 705/400; 340/988

(57) ABSTRACT

A system for repossessing a machine may include a transmitter configured to transmit a signal to the machine. The system may also include a receiver configured to receive a signal from the machine. The system may further include a controller in communication with the receiver and the transmitter. The controller may be configured to determine a location of the machine based on the signal received by the receiver, and to negotiate a repossession service rate from a repossession agent based on at least information associated with the machine or an ability to take an action with respect to the machine.

### TECHNICAL FIELD

The present disclosure relates generally to a method of repossessing a machine and, more particularly, to a method of assisting negotiation with a repossession agent for repossessing a machine.

### BACKGROUND

When a machine is stolen or a leased machine is in payment default, the owner or a lending institution, who is entitled to the machine, may commission a repossession agent to retrieve the machine. A repossession agent is a person or agency who provides services to repossess machines that are missing or in payment default. In order to repossess the machine, the repossession agent needs to locate the machine. Typically, the repossession agent has nothing more than the machine holder's last-known billing address. Sometimes, this address may no longer be valid, or the machine may not be kept or stored at such location. Therefore, the repossession agent has to spend a significant amount of time and effort on locating the machine. In addition, the default party may intentionally move the machine to an unknown location in order to hide the machine from being found, which may make the repossession processes more difficult, time consuming, and expensive. Once the machine is located, the repossession agent may need to deliver the machine to the owner or the lending institution which may be located remotely. Thus, if there is a way to accurately detect the location of the machine, prevent the machine from being moved away from the detected location, and provide the nearest drop-off location in relation to the location of the machine, it would significantly facilitate the repossession process. In addition, because the information provided to the repossession agent may save the repossession agent a significant amount of time and effort during the repossession process, the owner or the lending institution may use this information to negotiate a rate reduction with the repossession agent.

One method of retrieving machines such as automobiles is described in U.S. Pat. No. 6,025,774 (the '774 patent) issued to Forbes on Feb. 15, 2000. The '774 patent describes a method of securing collateral (e.g., a machine) for a loan based on a loan status. The method includes installing a transmitter within the machine. The transmitter is capable of transmitting locational data regarding the machine. The loan status is monitored for a default condition. A data link is established from a service center to the transmitter of the machine upon an occurrence of the default condition in the loan status. Locational data is transmitted from the transmitter of the machine to the service center via the data link. The location of the machine is determined from the locational data transmitted to the service center. Finally, the machine is relocated.

Although the system of the '774 patent may help to retrieve a machine, in many situations, the individual responsible for the loan may be actively avoiding being located by moving the machine away from the detected location. Thus, the machine confiscation process of the '774 patent may potentially be long and costly. In addition, the system of the '774 patent may be unable to restrict the operation of a machine, provide a location of the machine, or provide the nearest drop-off center to a repossession agent. Furthermore, the system of the '774 patent cannot assist in negotiation with a repossession agent.

The disclosed system is directed to overcoming one or more of the problems set forth above.

### SUMMARY OF THE INVENTION

In one aspect, the present disclosure is directed to a system for repossessing a machine. The system may include a transmitter configured to transmit a signal to the machine. The system may also include a receiver configured to receive a signal from the machine. The system may further include a controller in communication with the receiver and the transmitter. The controller may be configured to determine a location of the machine based on the signal received by the receiver and to negotiate a repossession service rate from a repossession agent based on at least information associated with the machine or an ability to take an action with respect to the machine.

In another aspect, the present disclosure is directed to a method of repossessing a machine. The method may include receiving signals from a transmitter coupled to the machine. The method may also include determining a location of the machine based on signals received from the transmitter. The method may further include negotiating a repossession service rate for repossessing the machine by offering to a repossession agent information associated with the machine or by disclosing to the repossession agent an ability to take an action with respect to the machine.

In yet another aspect, the present disclosure is directed to a method of repossessing a machine. The method may include receiving information associated with the machine. The method may also include determining a repossessing service rate based on the at least information associated with the machine or an ability to take an action with respect to the machine. The method may further include repossessing the machine in exchange for the repossessing service rate.

### BRIEF DESCRIPTION OF THE DRAWINGS

FIG. 1 symbolically depicts a machine repossession system according to one embodiment of the present disclosure;

FIG. 2 shows a flow diagram of a method according to one embodiment of the present disclosure;

FIG. 3 shows a flow diagram of exemplary steps of negotiation with a repossession agent; and

FIG. 4 shows a flow diagram of a method according to another embodiment of the present disclosure.

### DETAILED DESCRIPTION

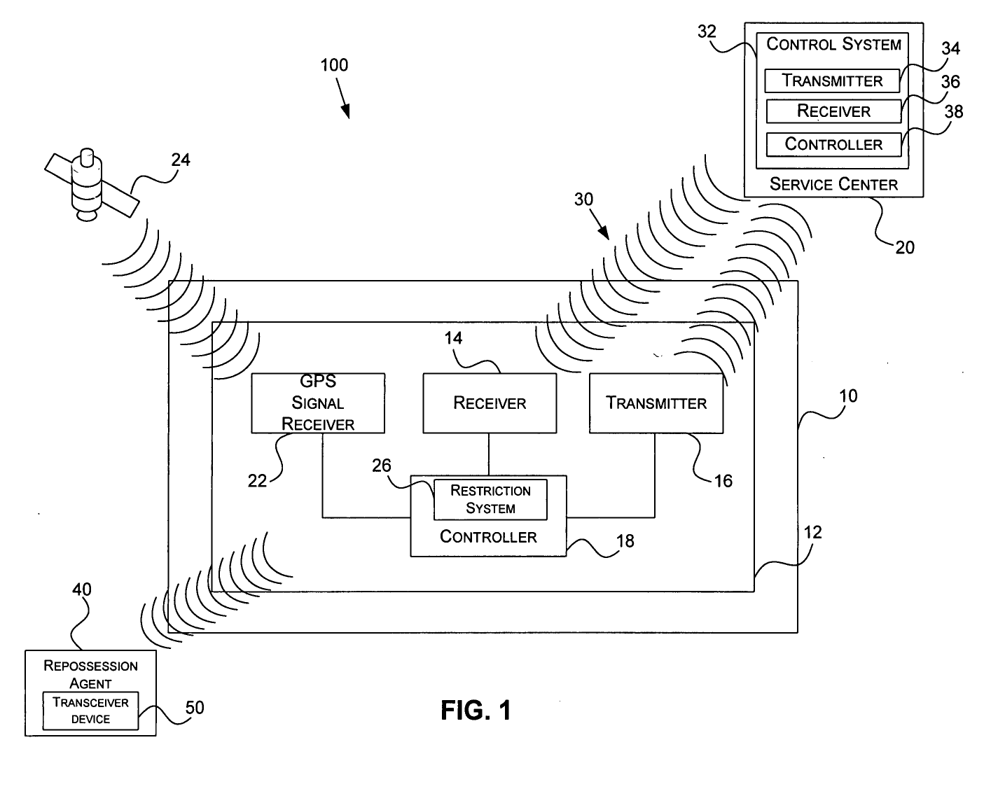

FIG. 1 illustrates an exemplary system 100 for repossessing a machine 10. As shown in FIG. 1, system 100 may include a repossession system 12 installed in machine 10, and a control system 32 installed in a service center 20. Machine 10 may embody a fixed or mobile machine that performs some type of operation associated with an industry such as mining, construction, farming, transportation, or any other industry known in the art. For example, machine 10 may be an earth moving machine such as an excavator, a dozer, a loader, a backhoe, a motor grader, a dump truck, or any other earth moving machine. For purposes of the present disclosure, the term “machine” includes but is not limited to automobiles, trucks, motor cycles, boats, house boats, airplanes, helicopters, house trailers, mobile homes, recreational machines, heavy machinery (such as tractors) and other devices used for transportation.

Repossession system 12 may include a receiver 14, a transmitter 16, and a controller 18. Receiver 14 and transmitter 16 may be electrically connected to controller 18. Receiver 14 and transmitter 16 may be capable of respectively receiving and transmitting signals from and to service center 20, which may be located remotely, through a wireless data communication link 30. Receiver 14 and transmitter 16 may include any communication device capable of receiving and transmitting signals.

Controller 18 may include any type of digital processing device, such as a microprocessor. The use of a microprocessor as controller 18 may provide versatility in programming and may include a relatively small size. Repossession system 12 may be made relatively small in size and hidden within machine 10, so that it may be difficult for a hostile party to disable or uninstall repossession system 12.

Control system 32 may include a transmitter 34 configured to transmit a signal to repossession system 12 in machine 10. Control system 32 may also include a receiver 36 configured to receive a signal from repossession system 12. Control system 32 may further include a controller 38 in communication with the receiver 36 and the transmitter 34.

Control system 32 in service center 20 may communicate with repossession system 12 to facilitate repossession of machine 10. Receiver 14 may be configured to receive a request signal from transmitter 34 of control system 32 at service center 20 through wireless data link 30, and controller 18 may process the request signal. In response, controller 18 may initiate transmitter 16 to transmit a response signal to receiver 36 of control system 32 at service center 20 via wireless data link 30. Controller 38 of the control system 32 may be configured to determine a location of the machine based on the response signal received by receiver 36.

Various methods for deriving such location information may be utilized. In one exemplary embodiment, the response signal from transmitter 16 may provide location information. In this respect, such signal may provide directional information which can be used to locate the emanating source, i.e., transmitter 16 in machine 10. In such an embodiment, receiver 36 may be located on a mobile device that can be used to track the signal from transmitter 16. Alternatively, service center 20 may, itself, be located on a mobile device that may directionally receive the response signal and eventually locate the source of the response signal.

In another embodiment, service center 20 may be in electronic communication with a plurality of service centers or an array of antennas. These service centers and/or array of antenna may be directionally sensitive and may enable triangulation techniques to locate machine 10.

In yet another embodiment, Global Positioning System (GPS) technology may be used to derive the location information of machine 10. Repossession system 12 may further be provided with a GPS signal receiver 22. GPS signal receiver 22 may be incorporated in receiver 14, and may be connected to controller 18. Upon the receipt of the transmit request signal by receiver 14, controller 18 may initiate GPS signal receiver 22, which may receive signals from satellites 24. As one of ordinary skill in the art will appreciate, the location information of machine 10 may be derived from the signals received by GPS signal receiver 22. Such location information may then be transmitted, as described above, to remote service center 20. It is contemplated that the location information may provide very precise information as to the location of machine 10, and therefore may facilitate repossession of machine 10.

In one embodiment, controller 18 may include a restriction system 26. Restriction system 26 may be configured to restrict the operation of machine 10 by only allowing the machine to move slowly (e.g., not operating in full power) or preventing the machine from being restarted once it has been turned off. The operation of machine 10 may be restricted by limiting power to at least one of a fuel system, a starter system, or an ignition system of machine 10. Shutting down machine 10 during operation may present safety issues, and therefore, restriction system 26 may be further configured to avoid disabling the machine when machine 10 is running for safety concerns.

Controller 18 or restriction system 26 may be further configured to allow machine 10 to be restarted upon receipt of a command signal from service center 20 or from the repossession agent. Alternatively, the repossession agent can be provided with a key or code that may allow the repossession agent to override restriction system 26 and relieve the restrictions on machine 10. Restricting operation of machine 10 may assist the repossession agent to repossess machine 10 because restricted machine 10 may only move in slow pace and may only have restricted functions.

Controller 38 may be configured to send a command signal to repossession system 12 of machine 10 to initiate restriction system 26 to restrict the operation of machine 10. Service center 20 may provide a repossession agent 40 the location of machine 10, then may restrict the operation of machine 10 to avoid machine 10 be removed or hidden by a default party. Service center 20 then may have repossession agent 40 repossess machine 10 at the location determined by service center 20. Controller 38 may be further configured to reenable machine 10. After repossession agent 40 repossesses machine 10, control system 32 may send a command signal to repossession system 12 to reenable machine 10. Repossession agent 40 may then deliver machine 10 to the nearest drop-off location.

In one embodiment, controller 38 may be configured to negotiate a repossession service rate from a repossession agent by offering the location of the machine and the nearest drop-off location determined based on the location of the machine. Controller 38 may be further configured to negotiate the repossession service rate from the repossession agent by offering to restrict the operation of the machine and relieve the restrictions on the machine. Alternatively, the negotiation may be performed by a person who may work for or be associated with the owner or the lending institution of the machine.

Repossession agent 40 may be provided with a transceiver device 50 (as shown in FIG. 1) that may be configured to communicate with controller 18 of machine 10. For example, transceiver device 50 may be configured to communicate wirelessly with machine 10. In one embodiment, transceiver device 50 may be configured to receive a command signal from service center 20 or repossession agent 40 and to send a command signal to machine 10 to restrict the operation of machine 10. Transceiver device 50 may also be configured to reenable machine 10. For example, in one embodiment, transceiver device 50 may be configured to send a command signal to machine 10 to relieve the restrictions on the machine when repossession agent 40 with transceiver device 50 is within a predetermined range of machine 10. Service center 20 may register transceiver device 50 when repossession agent 40 is commissioned to recover machine 40 (e.g., by recording a series number of transceiver device 50).

In one embodiment, repossession agent 40 may be authorized to distribute reenabling software, codes or reenabling keys to sub-agents that repossession agent 40 may use to recover machines, so that repossession agent 40 can delegate the repossession task to one or more sub-agents. Repossession agent 40 may also use the location information and the restricting/relieving features in negotiation with the sub-agents.

In addition, service center 20 may use the capability of restricting the machine and relieving the restrictions on the machine as an authorization means for certifying repossession agents who may be authorized to recover the machine. For example, a repossession agent may have to provide certain information (e.g., a certificate) to be authorized to recover the machine before obtaining the transceiver device, or the software, codes, or keys for restricting the machine and/or relieving the restrictions on the machine. Since only the certified repossession agents are given the codes or keys for restricting the machine and/or relieving the restrictions on the machine, the service center can certify repossession agents by checking whether they have authorized codes or keys to restrict the machine and/or relieve the restrictions on the machine. The mechanism also can be used by a repossession agent to certify sub-agents.

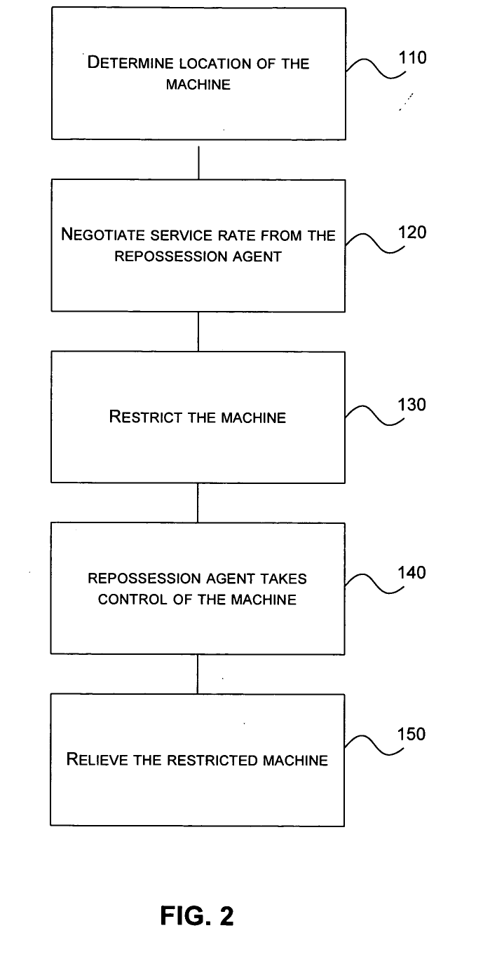

FIG. 2 shows a flow chart of an exemplary method of repossessing machine 10 in accordance with one embodiment of the present disclosure. At block 110, the location of machine 10 may be determined. Exemplary methods for determining the location of machine 10 have been described above. At block 120, a repossession service rate may be negotiated with the repossession agent. At block 130, a command signal to restrict machine 10 may be sent to machine 10 to restrict machine 10. At block 140 the repossession agent may take control of the machine. At block 150 the restrictions on machine 10 may be relieved.

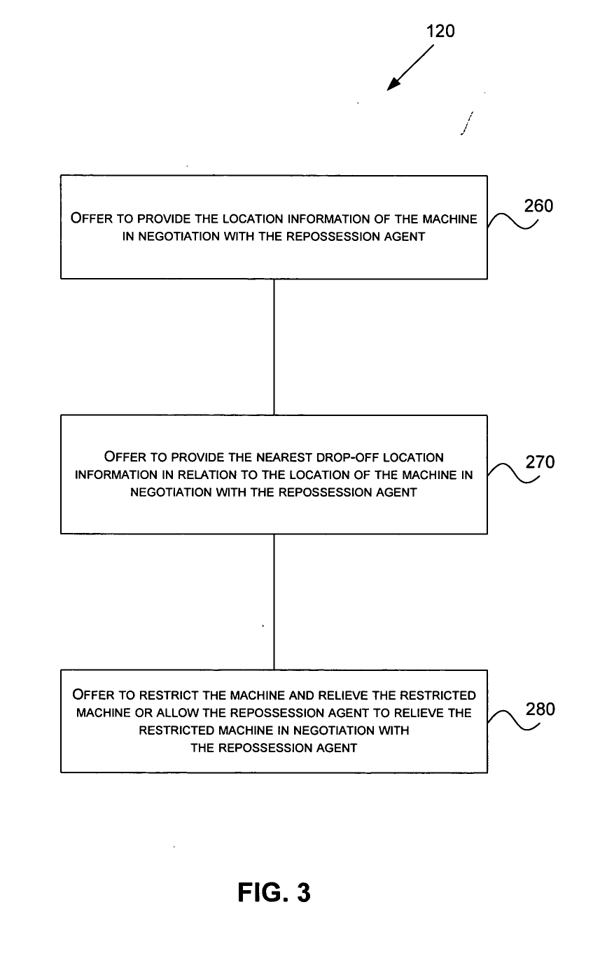

FIG. 3 shows detail steps of block 120. At step 260, the location information of machine 10 may be used in negotiation with the repossession agent to reduce the repossession service rate. At step 270, an offer can be made to provide the repossession agent with the nearest drop-off location (e.g., a dealer or a service center appointed by the owner) with respect to the location of machine 10. The nearest drop-off location information may be used in the negotiation to obtain a lower repossession service rate. For example, the repossession agent and/or the owner may determine the repossession service rate partially based on the distance from the machine to the nearest drop-off location. At step 280, in the negotiation, an offer can be made to restrict the machine and relieve the restrictions on the machine or to allow the repossession agent to restrict/relive the machine after the repossession agent locates the machine. These features may effectively assist the repossession agent to complete the task of repossessing the machine, and therefore, can be used to negotiate a further lower repossessing service rate from the repossession agent.

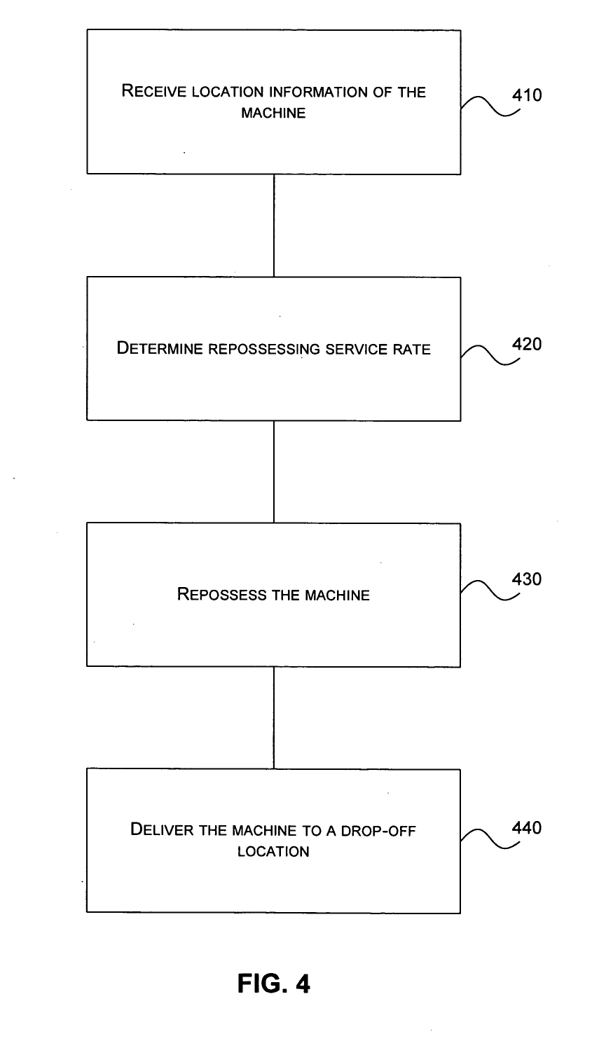

FIG. 4 shows a method of repossessing a machine according to yet another embodiment of the present disclosure. At block 410, the repossession agent may receive location information of the machine from repossession system 12 within the machine or from service center 20. At block 420, the repossession agent may determine a repossessing service rate. For example, this rate may be based on the location information of the machine, and/or on the location of the nearest drop off location, and whether the machine can be remotely restricted/relieved. At block 430, the repossession agent may repossess the machine based on information associated with the machine, e.g. the location information of the machine. At block 440, the repossession agent may deliver the machine to a drop-off location. This location may be determined at least partially based on the location of the machine. For example, the drop-off location may be a nearest drop-off location (e.g., a dealer or service center) determined based on the location information of the machine. Prior to locating the machine, the repossession agent may restrict or request the service center to restrict the machine. After the restricted machine is located, the repossession agent may relieve the restrictions on the machine or request the service center to relieve the restrictions on the machine.

### INDUSTRIAL APPLICABILITY

The disclosed method and system may be applicable to repossessing any items (e.g., machines). For example, the disclosed system and method may be utilized by an owner to repossess machines that are in payment default or may be utilized by financial institutions or any other entities who may have a lien, title, or any other right or interest in or associated with possession of the machine. The disclosed system and method may also be utilized to locate and recover machines that have been stolen. Because a significant portion of the costs of recovering the machine are associated with the agent's efforts in locating the machine, the disclosed system and method may enable the owner or the loan company to negotiate a relatively low service rate from the repossession agent by providing location information of the machine. Furthermore, the disclosed system and method may provide a mechanism to restrict the operation of the machine to prevent the machine from being moved away from the detected location. Also, a mechanism may be provided to allow the service center or the repossession agent to relieve the restrictions on the machine. The arrangement may facilitate the repossession agent to retrieve the machine, and reduce repossessing cost, and therefore, may further assist the owner to negotiate a relatively low repossession service rate with the repossession agent.

It will be apparent to those skilled in the art that various modifications and variations can be made to the method of assisting a repossession agent repossessing a machine. Other embodiments will be apparent to those skilled in the art from consideration of the specification and practice of the disclosed method of assisting a repossession agent repossessing a machine. It is intended that the specification and examples be considered as exemplary only, with a true scope being indicated by the following claims and their equivalents.

What is claimed is:

1. A system for repossessing a machine comprising:
a transmitter configured to transmit a signal to the machine;
a receiver configured to receive a signal from the machine; and
a controller in communication with the receiver and the transmitter, wherein the controller is configured to determine a location of the machine based on the signal received by the receiver, and to negotiate a repossession service rate from a repossession agent based on at least information associated with the machine or an ability to take an action with respect to the machine.

2. The system of claim 1, wherein the information includes the location information of the machine.

3. The system of claim 2, wherein the information includes drop-off location information determined based on the location information of the machine.

4. The system of claim 1, wherein the action includes restricting the operation of the machine.

5. The system of claim 4, wherein the action includes relieving the restricted machine.

6. The system of claim 1, wherein the action includes providing the repossession agent with information for restricting and relieving the restricted machine.

7. A method of repossessing a machine comprising:
receiving signals from a transmitter coupled to the machine;
determining a location of the machine based on signals received from the transmitter; and
negotiating a repossession service rate for repossessing the machine by offering to a repossession agent information associated with the machine or by disclosing to the repossession agent an ability to take an action with respect to the machine.

8. The method of claim 7, wherein the information includes the location of the machine or a drop-off location determined based on the location of the machine.

9. The method of claim 7, wherein the action includes:
restricting the operation of the machine and relieve the restricted machine.

10. The method of claim 7, further including:
restricting the operation of the machine.

11. The method of claim 10, wherein the restricting includes preventing the machine from being fully powered.

12. The method of claim 10, further including:
relieving the restricted machine after the machine has been repossessed.

13. The method of claim 10, further including:
providing the repossession agent with a transceiver device that is configured to communicate with the machine, and to relieve the restricted machine when the transceiver device is within a predetermined range of the machine.

14. The method of claim 10, wherein the restricting includes limiting power to at least one of a fuel system, a starter system, or an ignition system of the machine.

15. The method of claim 7, further including authorizing one or more agents to repossess the machine.

16. A method of repossessing a machine comprising:
receiving information associated with the machine;
determining a repossessing service rate based on at least the information associated with the machine or an ability to take an action with respect to the machine; and
repossessing the machine in exchange for the repossessing service rate.

17. The system of claim 16, wherein the information includes a location of the machine.

18. The system of claim 17, wherein the information includes a drop-off location determined based on the location of the machine.

19. The system of claim 16, wherein the action includes restricting the operation of the machine.

20. The system of claim 19, wherein the action includes relieving the restricted machine.
